(19) United States
(12) Patent Application Publication
(10) Pub. No.: US 2017/0149036 A1
(43) Pub. Date: May 25, 2017

(54) STEEL PRODUCT FOR PROTECTING ELECTRICAL COMPONENTS FROM MECHANICAL DAMAGE

(71) Applicant: SALZGITTER FLACHSTAHL GMBH, 38239 Salzgitter (DE)

(72) Inventors: MICHAEL BRAUN, Lehrte (DE); MANUEL OTTO, Cremlingen (DE); THOMAS EVERTZ, Peine (DE)

(73) Assignee: SALZGITTER FLACHSTAHL GMBH, 38239 Salzgitter (DE)

(21) Appl. No.: 15/322,015

(22) PCT Filed: Jun. 15, 2015
(86) PCT No.: PCT/EP2015/063333

§ 371 Date: Dec. 23, 2016

(30) Foreign Application Priority Data
Jun. 25, 2014 (DE) 10 2014 009 534.7

(51) Int. Cl. H01M 2/10; B32B 15/18; C21D 8/02; H01M 2/34; B22D 11/00; C22C 38/38; C22C 38/06; C22C 38/02; B32B 15/08; C21D 6/00

(52) U.S. Cl. CPC H01M 2/1094; B32B 15/08; B32B 15/18; C21D 8/0284; C21D 6/005; C21D 6/002; C21D 6/008; B22D 11/001; C22C 38/38; C22C 38/06; C22C 38/02; H01M 2/347; B32B 2307/206; B32B 2307/306; B32B 2307/714; B32B 2457/10; B32B 2597/00; H01M 2220/20; H01M 2200/00

(57) ABSTRACT

A steel product for protecting electrical components from mechanical damage and electrical short circuit resulting therefrom is disclosed. The steel product is produced from a lightweight steel comprising 6 to 30 wt % manganese, up to 12.0 wt % aluminum, up to 6.0 wt % silicon, 0.04 to 2.0 wt % carbon, and additionally one or more of the elements chromium, titanium, vanadium, niobium, boron, zirconium, molybdenum, nickel, copper, tungsten, cobalt at up to 5.0 wt % each and up to 10.0 wt % in total, the remainder iron, including common steel tramp elements, as hot-rolled strip or cold-rolled strip, sheet metal, or pipe, wherein the steel product is provided with an electrically non-conductive coating at least one side, on the side later facing the electrical components.

The invention relates to a steel product for protecting electrical components against mechanical damage. The invention in particular relates to use of such a steel product as protection for electrical systems that are at risk in the event of a crash and components in motor vehicles according to claim 1.

Electrical components that may be at risk in case of a crash can for example be energy storages such as high-voltage batteries located in motor vehicles, for example those used for electric vehicles. Such batteries are stored in stable canisters in order to protect the batteries in the event of a crash against damage due to deformation and possible formation of short circuits with surrounding metallic vehicle parts resulting therefrom and against fire. Similarly also electrical systems or components with high-voltage have to be protected in order to prevent consequential damage caused by a fire. The Official Gazette of the European Union (Regulation 94, Chapter 5.2.8.2 electrolyte leak) in addition regulates the avoidance of leakage of battery acid.

In the state of the art diverse possibilities are disclosed to protect batteries for electric vehicles against deformation and short circuits.

The laid open patent document DE 10 2010 006 514 A1 describes the necessity to protect the battery case/battery carrier against crash loads. In this case it is provided to use a device to pivot and/or displace the battery case out of the collision-/deformation region.

From the laid open patent document DE 10 2011 077 385 A1 a fastening structure for a vehicle battery case is known which is capable to avoid a short circuit of the battery when an impact force acts from the rear (rear-crash). For this purpose the fastening structure severs current-conducting parts in a targeted manner by displacement/frontward movement and interrupts the current circuit. Also this measure is very complicated to realize and does not reliably protect the battery itself against a short circuit with electrically conducting components.

In the laid open patent document DE 10 2012 004 135 A1 a battery case for a traction battery is described with a housing which is constructed in the monocoque construction with an upper and a lower shell made of plastic, wherein the upper shell is provided with an electrically conductive layer for electromagnetic shielding. Optionally the shells can in addition also be provided on their inside with an electrically shielding layer. This does not provide protection against possible short circuits in the event of a crash. Also the deformation capacity of plastic in the event of a crash is very limited in order to protect the battery effectively against damage.

From the laid open document DE 10 2009 037 138 A1 also a housing in monocoque construction is known, wherein in this case the lower shell is made of two components with an inner shell made of plastic and an outer shell which is either made of plastic or metal and is form fittingly or materially connected with the lower shell. Also in this case the mechanical and electrical protection of the battery is not sufficiently ensured.

But especially the hotly contested automobile market forces manufacturers to constantly seek solutions for lowering fleet consumption while at the same time maintaining a highest possible comfort and occupant protection. Hereby in electric vehicles beside power increase of the battery, especially the weight reduction of all vehicle components plays an important role to increase the range of the vehicle.

In addition also properties of the individual components that promote passive safety of the passengers in the event of high static and dynamic stresses during operation and in the event of a crash have to be realized. In the case of passive safety the protection of the high-energy vehicle battery against electrical short circuits and the resulting potential risk of fire is therefor especially important.

With the measures mentioned above however a sufficient mechanical protection of the electrical energy storage against deformation and electrical short circuits cannot be realized in a cost-effective and weight saving manner.

It is therefore an object of the invention to disclose a steel product for protection of electrical components against mechanical damage, in particular of an energy storage system in the motor vehicle which on one hand satisfies the requirements for crash safety and on the other hand offers protection against electrical short circuits in the event of deformation. In addition this steel product is to be weight saving and cost-effective to manufacture.

This object is solved with a steel product according to patent claim 1. Advantageous embodiments are the subject matter of dependent claims.

The teaching of the invention includes a steel product for protection of electrical components against mechanical damage and electrical short circuits resulting therefrom, the steel product being made of a lightweight construction steel with 6 to 30 weight % manganese, up to 12.0 weight % aluminum, up to 6.0 weight % silicone, 0.04 to 2.0 weight % carbon and additionally one or more of the elements chromium, titanium, vanadium, niobium, boron, zirconium, molybdenum, nickel, copper, tungsten, cobalt, each with up to 5 weight % and in sum together up to 10 weight %, remainder iron including common steel accompanying elements, as hot strip or cold rolled strip, sheet metal or tube, wherein the steel product is provided with an electrically non conducting layer on at least one side which later faces the electrical components.

High-manganese steels in the context of the invention are characterized by a partially stable Γ-solid solution microstructure with defined stacking fault energy with a partially multiple TRIP-effect which transforms the tension or stretch induced transformation of a face-centered γ-solid solution (austenite) into an ε-martensite (hexagonal densest cube packing) which then transforms upon further deformation into a body-centered α-martensite and residual. austenite. The high degree of deformation is achieved by TRIP—(Transformation induced Plasticity) and TWIP—(Twinning Induced Plasticity) properties of the steel.

Numerous tests have shown that in the complex interaction between Al, Si and Mn carbon is of paramount importance. Carbon on one hand increases the stacking fault energy and on the other hand expands the metastable austenite region. As a result the deformation-induced martensite formation and the strengthening associated therewith and also the ductility can be influenced over wide ranges.

As a result of the addition of further alloy elements such as Cr, Ti, V, Nb, B, Zr, Mo, Ni, Cu, W, Co with contents of up to 5.0 weight % and in sum together 10.0 weight % working material specific properties can additionally be adjusted in a targeted manner.

For example beside the increased addition of Al with up to 12.0% an addition of Co, Mo or V results in an increased high-temperature strength.

An increased high-temperature strength is for example advantageous in the case of high temperature stresses such as in the event of a fire because the integrity of the container can be maintained longer than in previously known α-martensite containing TRIP steels.

Particularly advantageous properties of a combination of high strength, deformation capacity, corrosion resistance and manufacturability can be achieved when the steel has the following chemical composition (in weight %):
Mn: 9-18
C: 0.07-1.0
Al: 0.04-4
Si: 0.04-4
Cr: 0.04-4

A minimal content of chromium of 2.0 weight % and maximal content of 4.0 weight % has proven advantageous with regard to corrosion resistance. In an amount below 2.0 weight % chromium does not show a significant effect on corrosion resistance. A solid solution forms and the chromium oxide layer responsible for corrosion resistance cannot form. When adding chromium at an amount of above 4.0 weight % the brittle Sigma phase can form after a long incubation time. With an amount of added chromium of 0.12 to <2.0 weight % on the other hand the ductility of the steel product according to the invention can be significantly increased and austenite can be stabilized in the high-manganese steel.

Particular properties regarding castability, hot formability and cold deformability the ductility can advantageously be adjusted when the mass contents of the alloy elements Mo (0.2-1 weight %), Cr (0.12-2 weight %) and Mn (12-17 weight %) are adjusted in combination with C (0.3-0.8 weight %), wherein according to the invention an austenitic state of the steel is still ensured. The contents of Al (1-3 weight %) and Si (0.5-2.5 weight %) are adjusted with regard to an optimal castability and a low sensitivity against hydrogen embrittlement of the steel.

Further improvements of the material properties can be achieved by targeted addition of copper and/or chromium. With the addition of copper of at least 0.1, advantageously at least 0.3 weight % the ε-martensite is stabilized and the galvanization capacity is improved. In addition copper increases the corrosion resistance of the steel. Also chromium stabilizes the ε-martensite and improves corrosion resistance.

With this the invention combines the excellent energy absorption and strengthening capacity of the material with a reliable electrical insulation for protection against short circuits in the case of deformation.

In order to satisfy these requirements the steel should have a minimal yield strength of 500 MPa, a minimal tensile strength of 800 MPa and a minimal elongation at break of A80 of 25%.

Due to its very good forming behavior the manufacture of complex components, such as for example protective cases for protection for electrical energy storages, can be realized from a low number of parts in spite of the high strength of this steel, in contrast to conventional construction methods (use of even plates, which have to be joined in a complicated manner (welding/screwing)).

In addition at least the side of the protective case which faces the energy storage is protected by an electrically insulating coating for preventing short circuits in the case of deformation, which layer is applied retroactively or preferably already prior to the forming as a film in a continuous process onto the generated steel strip for example with existing strip coating systems.

As a functional film this coating is for example corrosion resistant against acid (for example against accumulator acid) and has also non-conductive electrical properties. The thickness of the layer can for example be 0.05 to 0.5 mm depending on the requirements with regard to the non-conductive anti-corrosive properties and can be made of one or multiple layers.

In the case of a single-layered construction the coating is advantageously made of plastic. With a multi-layered construction of the coating a broad variety of different demands regarding electrical insulation and corrosion resistance can be taken into account. The coating can for example be, made of a plastic layer and a metallic layer such as for example a metal film, wherein the thickness of the individual layers an be varied depending o the requirements at hand.

The metallic shell of the protective case made of high-manganese steel serves in particular for mechanical protection of the energy storage and electromagnetic shielding. In addition the material advantageously has paramagnetic properties. In addition a reduction of the component weight is achieved by the density-reducing alloy elements manganese, aluminum and silicone.

The steel product according to the invention thus represents an integration of functions. It offers protection in thee vent of excessive deformation resulting from a crash and short circuits that may be caused thereby and against electromagnetic effects, and electromagnetic compatibility.

The advantages of the invention are thus an improvement of the protection against damage to accumulators in the event of a deformation of the vehicle or the energy storage and uncontrollable short circuits and the avoidance of the risk due to fire or explosion or leakage of liquids form the accumulator.

At the same time a the component weight is reduced due to the reduction of the density of the high-manganese steel. In addition a manufacture of very complex non-flat components is enabled through forming from one or a low number of sheet metal parts or tubes and with this higher constructive freedom regarding the construction and integration of the accumulator into the vehicle body is achieved. In addition when using the high-manganese steel forming possibilities are realized which allow a construction from steel in the first place.

Generally during manufacture of steel sheet as semi-finished product, the liquid steel is cast continuously into slabs with 50-400 mm thickness and subsequently rolled to the required final thickness, usually about 2-5 mm. Beside the energy for the rolling further energy for reheating the steel in furnaces between the processing steps is required.

In the conventional production of the steel according to the invention by means of slab casting technology, however, there are significant problems to generate high-quality steel sheets. The reasons for this are essentially segregation of the alloy elements (macro segregation), formation of hollow spaces during the solidification (blowholes) and coarse grain formation and the massive casting powder contamination as a result of the high aluminum contents.

A particularly advantageous way for producing the lightweight steel according to the invention has proven the manufacture by means of strip casting technology as for example known from EP 1 699 5892 B1. The manufacture of the lightweight steel for the steel product according to the intention is made possible by the fundamentally changed strip casting technology in which the liquid steel is directly cast in thicknesses from 6 to 15 mm onto a special horizontal belt, which moves with casting speed, and is subsequently rolled. As a result of the low casting thickness significantly shorter time intervals for adjusting the temperature distribution prior to the directly following inline rolling process are required.

Beside strips as semi-finished product also tubes can advantageously be produced from the thusly-produced strips by forming and subsequent welding, which tubes are subsequently provided with a non-conducive coating which can also be configured one-layered or multi-layered.

From the thusly-produced steel products the components for protection against mechanical damage for electrical energy storage systems, electrical systems or devices are subsequently generated. These can be for example housings, containers or cages made of sheet metal and/or tubes.

Beside the production by strip casting the steel alloy according to the invention can also advantageously be used as casting material for example for components with very complex geometry which cannot be produced by forming.

The advantage of the proposed lightweight steel for the steel product according to the invention is that as a result of targeted alloy composition and the selection of the process parameters, such as degree of deformation and heat treatment, a broad spectrum of strength and ductility requirements can be covered, wherein tensile strengths of up to 1400 MPa are possible.

Even though the invention is suited for encapsulating high-energy vehicle batteries the lightweight steel used therefore is not limited to this application, but of course can be used everywhere where electrical systems and components have to be protected against mechanical damage and electrical short circuits and the risks associated therewith have to be prevented. This may for example include applications in the filed of machine construction or power plant construction or military technology.

The steel products according to the invention can also be stationary, i.e., fixedly installed protective constructions such as containers, boxes, cages etc as well as corresponding transportable protective constructions.

The steel product according to the invention can hereby meet multiple protective functions. In the case of battery boxes the protective function can for example relate to the protection of the battery against mechanical damage and electrical short circuits as well as to protection against liquids that may leak out of the battery, such as battery acid. In this case the steel product is configured as a liquid tight housing.

What is claimed is:

1.-14. (canceled)

15. A steel product for protection of electrical components against mechanical damage and electrical short circuits resulting therefrom, said steel product being produced from a light weight steel with 6 to 30 weight % manganese, up to 12.0 weight % aluminum, up to 6.0 weight % silicone, 0.04 to 2.0 weight % carbon and additionally one or more of the elements chromium, titanium, vanadium, niobium, boron, zirconium, molybdenum, nickel, copper, tungsten, cobalt each with up to 5 weight % and in sum together up to 10 weight %, remainder iron including common steel accompanying elements, as hot strip or cold rolled strip, sheet metal or tube, wherein the steel product is provided with an electrically non-conductive coating on at least one side which later faces the electrical components.

16. The steel product of claim 15, having the following chemical composition (in weight %):
Mn: 9-18
C: 0.07-1.0
Al :0.04-4
Si: 0.04-4
Cr: 0.04-4

17. The Steel product of claim 15, having the following chemical composition (in weight %):
Mn: 12-17
C: 0.3-0.8
Al: 1-3
Si: 0.5-2.5
Cr: 0.12-<2
Mo: 0.2-1

18. The steel product of claim 15, having a minimal yield strength of 500 MPa, a minimal tensile strength Rm of 800 MPa and a minimal elongation at break A80 or at least 25%.

19. The steel product of claims 15, wherein the electrical insulating coating is configured one-layered or multi-layered.

20. The steel product of claim 19, wherein the one-layered coating is a plastic coating.

21. The steel product of claim 19, wherein the multi-layered coating is made of a layer of plastic and a layer of metal.

22. The steel product of claim 20, wherein the coating is applied in a continuous process onto the strip.

23. The steel product of claim 15, wherein the coating is acid resistant.

24. The steel product of claim 23, wherein that the coating is resistant against accumulator acid.

25. The steel product of claim 15, produced by casting a steel melt in a horizontal strip casting system in a thickness of 6 to 15 mm, subsequently rolling into a hot or cold strip and subsequent coating with a non-conductve one layered or multi-layered coating in a continuous strip coating system.

26. The steel product of claim 15, produced by a casting of a steel melt in a horizontal strip casting system in a thickness of 6 to 15 mm subsequent rolling to a hot or cold strip, forming the strip into an open-seam tube and welding to a tube and coating the tube with a non-conductive one layered or multi-layered coating.

27. The steel product of claim 15, for use for production of components for protection against mechanical damage for electrical energy storage systems, electrical systems or devices.

28. A component made of the steel product of claim 15, for producing housings, containers or cages made of sheet metal and/or tubes.
